(19) United States
(12) Patent Application Publication
(10) Pub. No.: US 2018/0150615 A1
(43) Pub. Date: May 31, 2018

(54) DEVICE FOR FACILITATING CLINICAL TRIAL

(71) Applicant: Accenture Global Solutions Limited, Dublin (IE)

(72) Inventors: Chad A. ASTON, Sonoma, CA (US); Ronan WISDOM, Ashburn, VA (US); Andrew D. GREENBERG, Wynnewood, PA (US); Katie STRASSER, Audubon, PA (US); Nicholas DAVIES, Chestnut Hill, MA (US); Ian C. SHAFER, Tabernacle, NJ (US)

(21) Appl. No.: 15/365,452

(22) Filed: Nov. 30, 2016

(51) Int. Cl. G06F 19/00

(52) U.S. Cl. CPC G06F 19/363; G06F 19/322

(57) ABSTRACT

A device may receive trial information that identifies rules or requirements associated with a clinical trial. The device may identify a set of participants associated with the clinical trial. The device may automatically obtain, from a user device associated with a particular participant, of the set of participants, first information regarding the particular participant. The first information may relate to a biometric of the particular participant or an environment associated with the particular participant. The device may determine that the first information indicates that the particular participant does not satisfy a particular rule or requirement associated with the clinical trial. The device may provide, to the user device, a prompt indicating that the particular participant does not satisfy the particular rule or requirement. The device may store or provide the first information for addition to a profile associated with the particular participant.

### BACKGROUND

Clinical trials are experiments, performed in clinical research, which are applied to participants such as human volunteers. Clinical trials may be performed to better understand how a specific disease presents or to determine the safety and effectiveness of medications, devices, diagnostic products, or treatment regimens intended for human use. A clinical trial is typically administered in accordance with a protocol that defines the parameters of the clinical trial, including who may participate, frequency and dosage of medication to be taken, data to be collected, etc. Thus, in order to perform a clinical trial, participants must be found who fit the necessary profile and efforts must be employed to have them follow the protocol through the period of the trial.

### SUMMARY

According to some possible implementations, a device may include one or more processors. The one or more processors may receive trial information that identifies rules or requirements associated with a clinical trial. The one or more processors may identify a set of participants associated with the clinical trial. The one or more processors may automatically obtain, from a user device associated with a particular participant, of the set of participants, first information regarding the particular participant. The first information may relate to a biometric of the particular participant or an environment associated with the particular participant. The one or more processors may determine that the first information indicates that the particular participant does not satisfy a particular rule or requirement associated with the clinical trial. The one or more processors may provide, to the user device, a prompt indicating that the particular participant does not satisfy the particular rule or requirement. The one or more processors may store or provide the first information for addition to a profile associated with the particular participant.

According to some possible implementations, a method may include receiving, by a first device, trial information that identifies rules or requirements associated with a clinical trial. The method may include identifying, by the first device, a set of participants associated with the clinical trial. The method may include automatically obtaining, by the first device and from a second device associated with a particular participant, of the set of participants, first information regarding the particular participant. The first information may relate to a biometric of the particular participant or environmental conditions associated with the particular participant. The method may include determining, by the first device and based on the first information, that the particular participant has violated a particular rule or requirement associated with the clinical trial. The method may include providing, by the first device and to the second device, a prompt indicating that the particular participant has violated the particular rule or requirement. The method may include storing or providing the first information for addition to a profile associated with the particular participant.

According to some possible implementations, a non-transitory computer-readable medium may store one or more instructions that, when executed by one or more processors, may cause the one or more processors to receive trial information that identifies rules or requirements associated with a clinical trial. The one or more instructions, when executed by one or more processors, may cause the one or more processors to identify a set of participants associated with the clinical trial. The one or more instructions, when executed by one or more processors, may cause the one or more processors to automatically obtain, from a user device associated with a particular participant, of the set of participants, first information regarding the particular participant. The first information may relate to a biometric of the particular participant or an environment associated with the particular participant. The first information may be obtained via a secure connection. The one or more instructions, when executed by one or more processors, may cause the one or more processors to determine that the first information indicates that the particular participant does not satisfy a particular rule or requirement associated with the clinical trial. The one or more instructions, when executed by one or more processors, may cause the one or more processors to provide, to the user device, a prompt indicating that the particular participant does not satisfy the particular rule or requirement. The one or more instructions, when executed by one or more processors, may cause the one or more processors to store or provide the first information for addition to a profile associated with the particular participant.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for identifying potential participants to be added to a clinical trial participation pool;

FIG. 5 is a flow chart of an example process for selecting participants from a clinical trial participation pool to participate in a clinical trial; and

FIG. 6 is a flow chart of an example process for administering a clinical trial.

### DETAILED DESCRIPTION

The following detailed description of example implementations refers to the accompanying drawings. The same reference numbers in different drawings may identify the same or similar elements.

A healthcare or life sciences organization may administer a clinical trial to better understand a disease or to test a medical drug or treatment. In doing so, the organization may attempt to control variables relating to a population of participants to determine an effect of the medical drug or treatment, such as efficacy, side effects, or the like.

Administering a clinical trial and finding participants can be challenging for many reasons. As one example, clinical researchers may need to advertise in print media or via broadcast media when attempting to identify participants for a clinical trial. Alternatively, researchers may need to canvas medical professionals, such as treating physicians, to identify eligible participants. These techniques may can be inefficient because the researchers may have to screen through many potential participants to determine if any are satisfy eligibility requirements for the clinical trial. In addition, physical distance between viable participants and investigator sites may render it difficult to locate the clinical trial in a way that is accessible to a sufficient number of participants. As yet another example, it may be expensive and time consuming to identify and sign up investigators to enroll patients in the trial. Furthermore, there may be a disparity in access to clinical testing locations among participants from different demographics. As still another example, gathering relevant medical history may be difficult and time consuming. Additionally, redundant gathering of data may occur when a participant participates in multiple trials. As yet another example, it may be difficult to ensure that a participant actually adheres to the rules of the clinical trial. Further, it may be difficult to efficiently and securely gather data for the clinical trial.

Implementations, described herein, may provide an clinical trial platform for clinical trials. The clinical trial platform may receive participant information for people who are interested in participating in clinical trials, and may add those people to a pool of available participants. The clinical trial platform may select available participants for clinical trials from the pool based on attributes of the available participants. The clinical trial platform may automatically obtain additional information from selected participants, such as signatures, consent, or the like. Based on the additional information, the clinical trial platform may create or update a data structure, such as a database. In administering the clinical trial, the clinical trial platform may collect clinical information and may improve adherence to rules based on providing adherence prompts to the participants. The clinical trial platform may store the newly obtained information in association with participant profiles.

In this way, the clinical trial platform may enable analysis of participant information gathered in many different clinical trials, and may reduce double-keying of information. Additionally, the clinical trial platform may improve matching of participants with clinical trials by more efficiently matching participants to clinical trials as opposed to conventional techniques. Furthermore, the clinical trial platform may improve adherence of participants to the requirements of the clinical trials. Still further, the clinical trial platform may reduce reliance on humans (e.g., local medical professionals) to gather information associated with clinical trials. Still further, the clinical trial platform may allow for the collection and aggregation of disparate data types previously not available as part of a trial. Additionally, the clinical trial platform may improve security of the clinical trial process.

Notably, in some implementations, the clinical trial platform may perform such operations based on a combination of clinical information, personal information, and ambient information. Clinical information may include information obtained from medically regulated devices or data otherwise collected in a fashion that satisfies regulatory requirements (e.g., patient-reported outcomes, information gathered by a field worker, etc.). Personal information may include non-regulated information gathered by a device (e.g., a patient weight, an activity level measurement, a sleep quality measurement, a measurement obtained by a wearable device, such as a FitBit, etc.). Ambient information may include information regarding an environment associated with a patient, such as weather information, pollen count, humidity, or the like. The clinical trial platform may use this information to generate adherence prompts, and to enable more robust analysis of gathered information to identify efficacy of a medication based on environmental or personal variables.

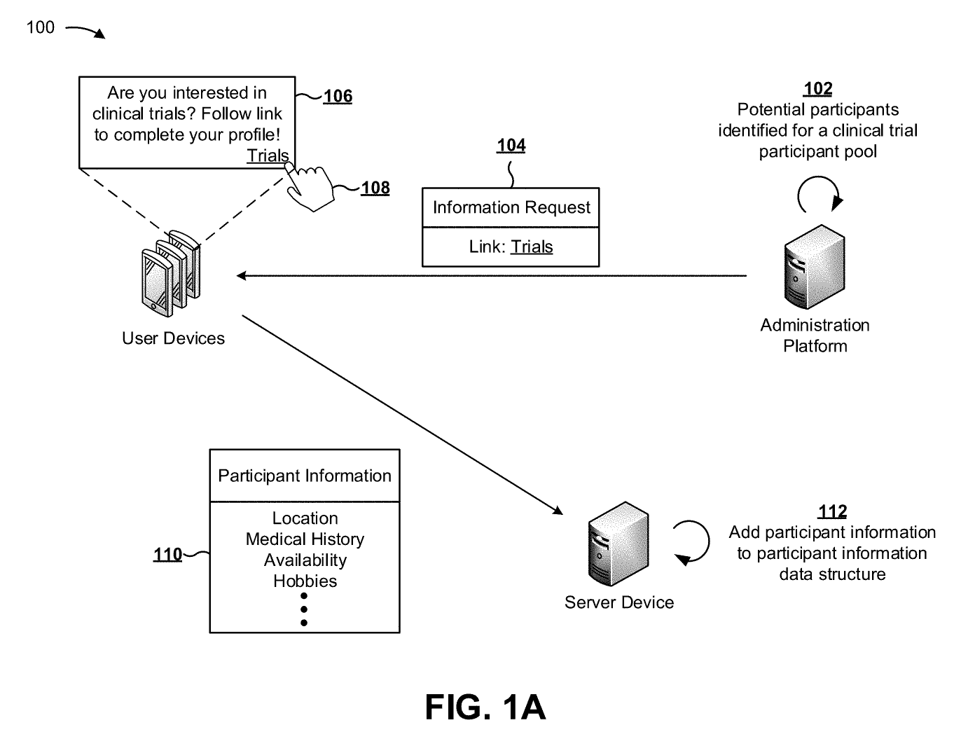

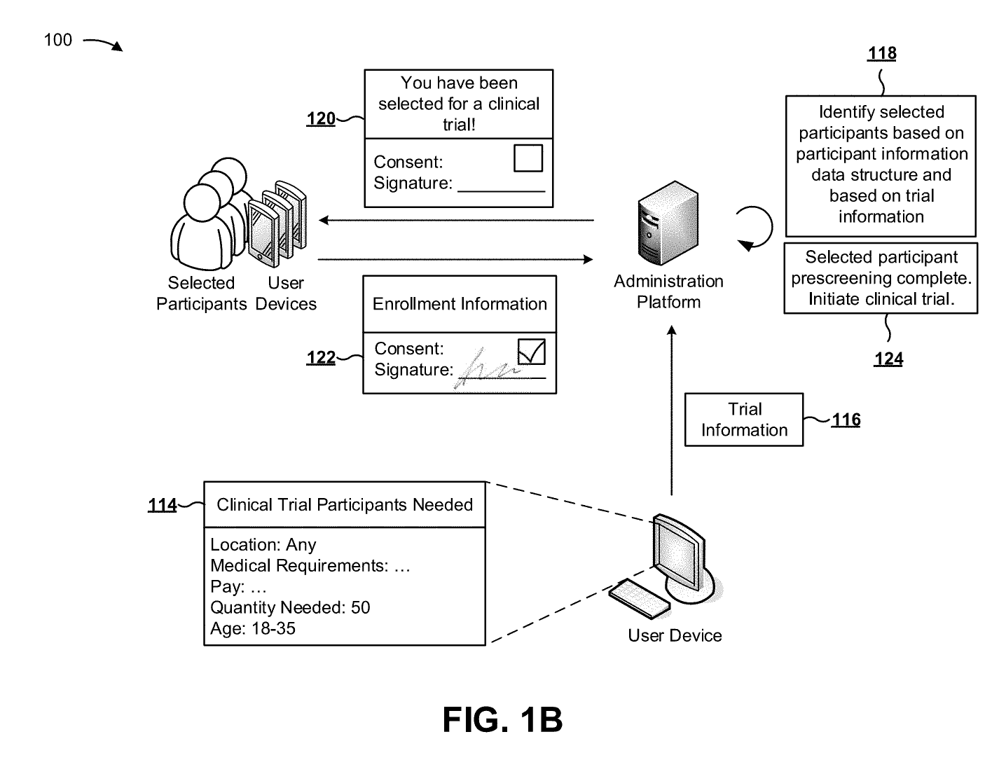

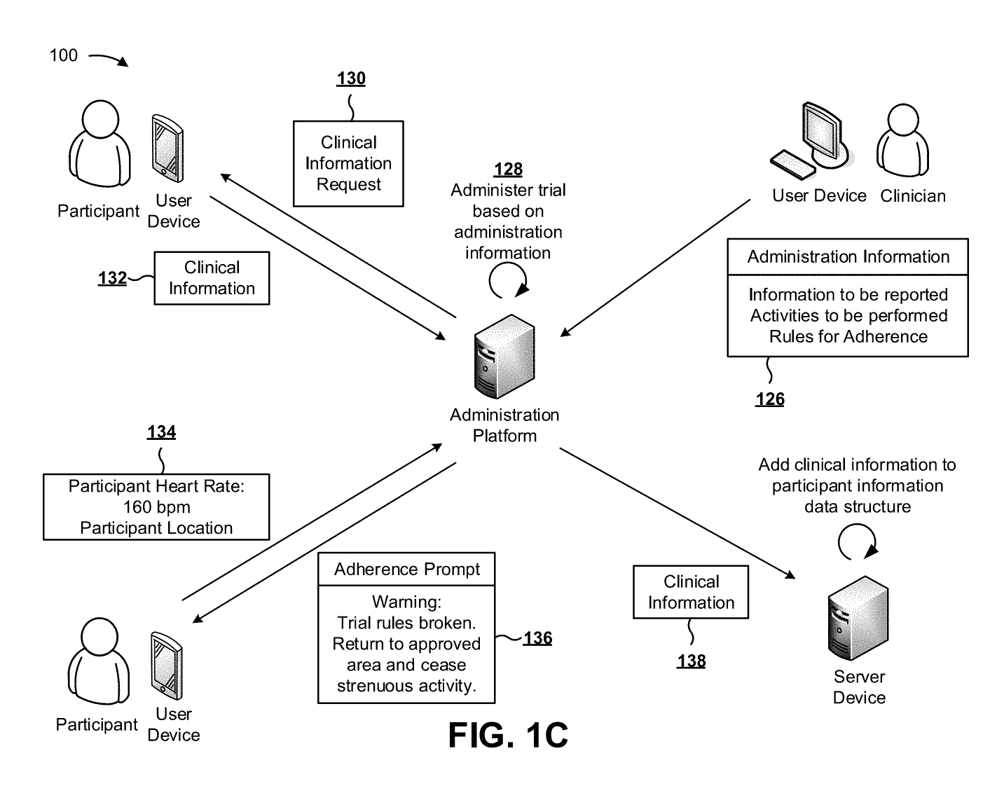

FIGS. 1A-1C are diagrams of an overview of an example implementation 100 described herein. As shown in FIG. 1A, example implementation 100 may include an clinical trial platform, user devices, and a server device (e.g., a server). As shown by reference number 102, the clinical trial platform may identify a potential participant for a clinical trial participant pool. For example, the clinical trial platform may identify the potential participant based on demographic information associated with the potential participant, based on past participation of the potential participant in one or more clinical trials, or the like.

As shown by reference number 104, the clinical trial platform may provide, to a user device of the potential participant, an information request for participant information associated with the potential participant. The participant information may include, for example, a location associated with the potential participant, a schedule of availability of the potential participant, personal information associated with the potential participant, or the like. As shown by reference number 106, the information request may cause a user interface of the user device to display a “call to action,” directed to the potential participant, to determine whether the potential participant might be added to the clinical trial participant pool. The call to action may include an advertisement, an email, a text message, a notification on a social network, a post on an internet forum or message board, a prompt within a software application (e.g., an app running on the user device), or the like.

As shown by reference number 108, the call to action may include a link (e.g., shown as “Trials”) which a user of a user device can select to indicate interest in being a clinical trial participant. Upon selecting the link, the user may provide participant information such as the user's location, medical history, availability, hobbies, or the like. As shown by reference number 112, the participant information may be provided to a server device. The server device may add the participant information to a participant information data structure. By providing the participant information directly to the server and not via the clinical trial platform, security of the participant information is improved and processor resources of the clinical trial platform are conserved. In some implementations, the link shown by reference number 108 may be a “deep link” which causes relevant information to be provided or stored to a specific location on the server device (e.g., without being processed by and/or routed via the clinical trial platform), thus conserving resources of the server device and/or the clinical trial platform that would otherwise be used to process the relevant information.

As shown in FIG. 1B, and by reference number 114, a user device may receive trial information that identifies one or more criteria for selecting participants in a clinical trial (e.g., location, medical requirements, age, etc.). As shown by reference number 116, the user device may provide the trial information to the clinical trial platform. As shown by reference number 118, the clinical trial platform may identify one or more selected participants for the clinical trial based on the trial information and based on the participant information data structure. For example, the clinical trial platform may match the attributes identified by the trial information with attributes of the one or more selected participants.

As shown by reference number 120, the clinical trial platform may notify a selected participant by sending an indication of the selection to a user device of the selected participant, and may request the consent of the selected participant. As shown by reference number 122, the clinical trial platform may obtain enrollment information associated with the selected participant, such as a consent signature. In some implementations, the enrollment information may include other information needed to perform the clinical trial, such as payment information, an updated medical history, or the like. As shown by reference number 124, prescreening of the selected participant may then be complete, and the clinical trial may be initiated.

As shown in FIG. 1C, and continuing with example implementation 100, the clinical trial platform may administer the trial to selected participants. As shown by reference number 126, the clinical trial platform may receive administration information that relates to participation in a clinical trial by a set of participants, such as information to be reported, activities to be performed, rules for adherence, or the like. As shown by reference number 128, the clinical trial platform may administer the clinical trial based on the administration information.

As shown by reference number 130, to administer the clinical trial, the clinical trial platform may provide a clinical information request to a participant in the clinical trial via a user device of the participant. As shown by reference number 132, the clinical trial platform may obtain clinical information relating to participation in the clinical trial.

As shown by reference number 134, to administer the clinical trial, the clinical trial platform may receive personal information from a user device indicating a participant is not in adherence with clinical trial rules, such as a heart rate that exceeds a threshold, or a participant location that violates a clinical trial rule. For example, this personal information may be received from a wearable device associated with the participant, from a user device associated with a nurse or field worker, or from another type of device. As shown by reference number 136, the clinical trial platform may provide an adherence prompt to the user device to improve adherence to the requirements of the clinical trial by the participant. As shown by reference number 138, to administer the clinical trial, the clinical trial platform may provide clinical information to the server, and the server may add the clinical information to the participant information data structure. In some implementations, the clinical trial platform may process the clinical information, may identify particular clinical information that is to be provided, may analyze particular clinical information, or the like. In some implementations, the clinical trial platform may receive and/or process ambient information to administer the clinical trial. For example, the clinical trial platform may generate adherence prompts based on trial information and ambient information, may analyze particular clinical information based on the ambient information, may identify outcomes of the clinical trial based on the ambient information, or the like.

In this way, the clinical trial platform may enable analysis of participant information gathered in many different clinical trials, and may reduce double-keying of information by local medical professionals. Additionally, the clinical trial platform may improve matching of participants with clinical trials based on attributes of the participants and the clinical trials. Furthermore, the clinical trial platform may improve adherence of participants to the requirements of the clinical trials. Still further, the clinical trial platform may reduce reliance on humans (e.g., local medical professionals) to gather information associated with clinical trials. Additionally, the clinical trial platform may improve security of the clinical trial process. Further, the clinical trial platform may improve safety of the trial process. For example, the clinical trial platform may determine that a participant's vital signs satisfy a particular threshold (e.g., based on a user device associated with the participant), and may transmit a message indicating that the participant is to cease taking a medication, visit a medical professional, or the like. Finally, the clinical trial platform may collect “ambient” data about the participant's environment at specific points in time and provide additional analysis of that data in combination with other data collected.

As indicated above, FIGS. 1A-1C are provided merely as an example. Other examples are possible and may differ from what was described with regard to FIGS. 1A-1C.

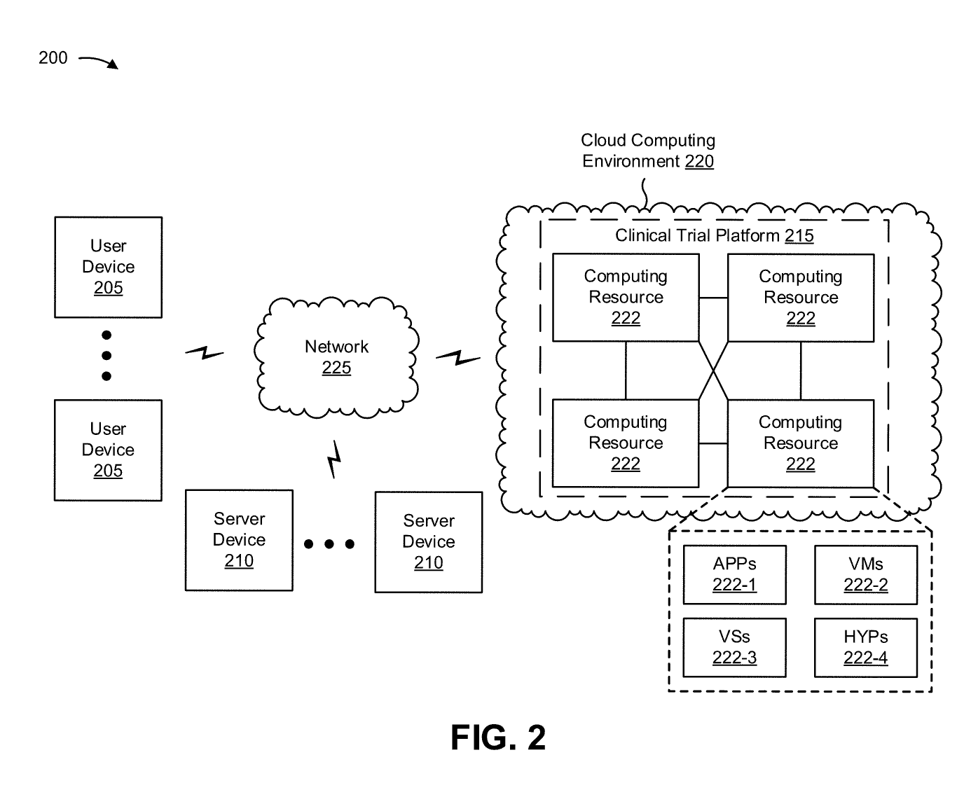

FIG. 2 is a diagram of an example environment 200 in which systems and/or methods described herein may be implemented. As shown in FIG. 2, environment 200 may include one or more user devices 205, one or more server devices 210, an clinical trial platform 215 hosted within a cloud computing environment 220, and a network 225. Devices of environment 200 may interconnect via wired connections, wireless connections, or a combination of wired and wireless connections.

User device 205 includes one or more devices capable of receiving, generating, storing, processing, and/or providing information associated with clinical trial platform 215, such as information associated with one or more applications of clinical trial platform 215. For example, user device 205 may include a communication and computing device, such as a mobile phone (e.g., a smart phone, a radiotelephone, etc.), a laptop computer, a desktop computer, a tablet computer, a handheld computer, a wearable communication device (e.g., a smart wristwatch, a pair of smart eyeglasses, etc.), or a similar type of device. In some implementations, user device 105 may include one or more medical devices (e.g., sensors, monitors, etc.) via which data may be gathered.

Server device 210 includes one or more devices capable of receiving, collecting, obtaining, gathering, storing, processing, and/or providing information associated with a patient and/or a treatment associated with the patient. For example, server device 210 may include a server or a group of servers. In some implementations, server device 210 may include a device that stores or has access to patient information that is to be used by clinical trial platform 215. In some implementations, server device 210 may be capable of providing information to clinical trial platform 215.

Clinical trial platform 215 includes one or more devices capable of receiving, determining, processing, storing, and/or providing information associated with one or more patient services associated with a patient and/or a treatment associated with the patient. For example, clinical trial platform 215 may include a server or a group of servers. In some implementations, clinical trial platform 215 may host a suite of applications associated with the one or more patient services. In some implementations, clinical trial platform 215 may include a workflow orchestration component as described herein.

In some implementations, as shown, clinical trial platform 215 may be hosted in cloud computing environment 220. Notably, while implementations described herein describe clinical trial platform 215 as being hosted in cloud computing environment 220, in some implementations, clinical trial platform 215 may not be cloud-based or may be partially cloud-based.

Cloud computing environment 220 includes an environment that hosts clinical trial platform 215. Cloud computing environment 220 may provide computation, software, data access, storage, etc. services that do not require end-user (e.g., user device 205) knowledge of a physical location and configuration of system(s) and/or device(s) that hosts clinical trial platform 215. As shown, cloud computing environment 220 includes a group of computing resources 222 (referred to collectively as “computing resources 222” and individually as “computing resource 222”).

Computing resource 222 includes one or more personal computers, workstation computers, server devices, or another type of computation and/or communication device. In some implementations, computing resource 222 may host clinical trial platform 215. The cloud resources may include compute instances executing in computing resource 222, storage devices provided in computing resource 222, data transfer devices provided by computing resource 222, etc. In some implementations, computing resource 222 may communicate with other computing resources 222 via wired connections, wireless connections, or a combination of wired and wireless connections.

As further shown in FIG. 2, computing resource 222 may include a group of cloud resources, such as one or more applications (“APPs”) 222-1, one or more virtual machines (“VMs”) 222-2, virtualized storage (“VSs”) 222-3, one or more hypervisors (“HYPs”) 222-4, or the like.

Application 222-1 includes one or more software applications that may be provided to or accessed by user device 205. Application 222-1 may eliminate a need to install and execute the software applications on user device 205. For example, application 222-1 may include software associated with clinical trial platform 215 and/or any other software capable of being provided via cloud computing environment 220. In some implementations, one application 222-1 may send/receive information to/from one or more other applications 222-1, via virtual machine 222-2.

Virtual machine 222-2 includes a software implementation of a machine (e.g., a computer) that executes programs like a physical machine. Virtual machine 222-2 may be either a system virtual machine or a process virtual machine, depending upon use and degree of correspondence to any real machine by virtual machine 222-2. A system virtual machine may provide a complete system platform that supports execution of a complete operating system (“OS”). A process virtual machine may execute a single program, and may support a single process. In some implementations, virtual machine 222-2 may execute on behalf of a user (e.g., user device 205), and may manage infrastructure of cloud computing environment 220, such as data management, synchronization, or long-duration data transfers.

Virtualized storage 222-3 includes one or more storage systems and/or one or more devices that use virtualization techniques within the storage systems or devices of computing resource 222. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 222-4 provides hardware virtualization techniques that allow multiple operating systems (e.g., “guest operating systems”) to execute concurrently on a host computer, such as computing resource 222. Hypervisor 222-4 may present a virtual operating platform to the guest operating systems, and may manage the execution of the guest operating systems. Multiple instances of a variety of operating systems may share virtualized hardware resources.

Network 225 includes one or more wired and/or wireless networks. For example, network 225 may include a cellular network (e.g., a long-term evolution (LTE) network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

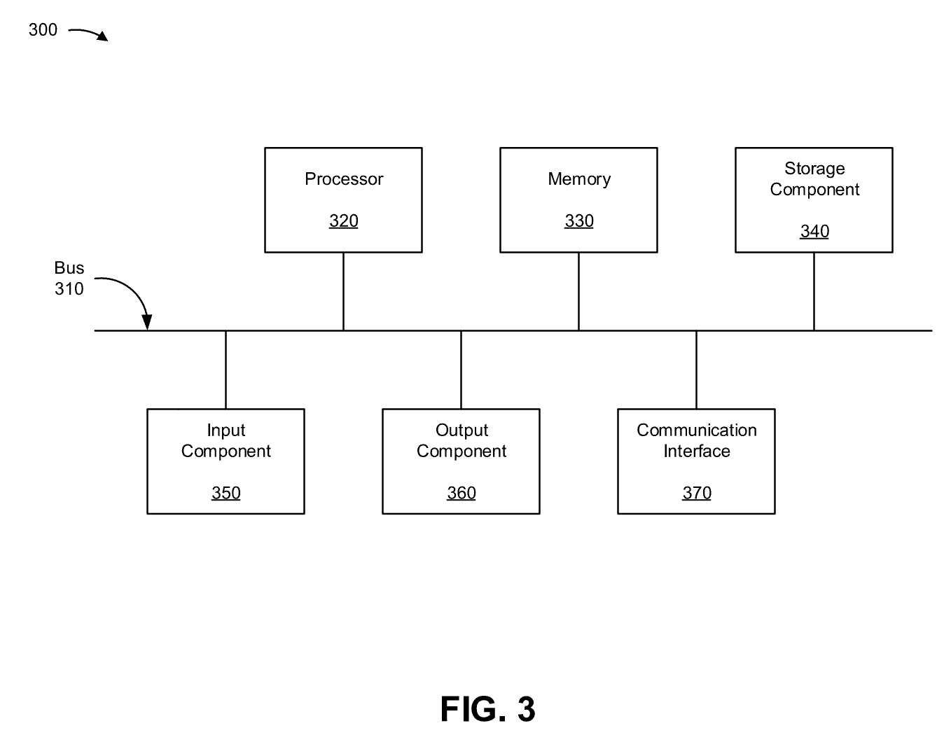

FIG. 3 is a diagram of example components of a device 300. Device 300 may correspond to user device 205, server device 210, and/or clinical trial platform 215. In some implementations, user device 205, server device 210, and/or clinical trial platform 215 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

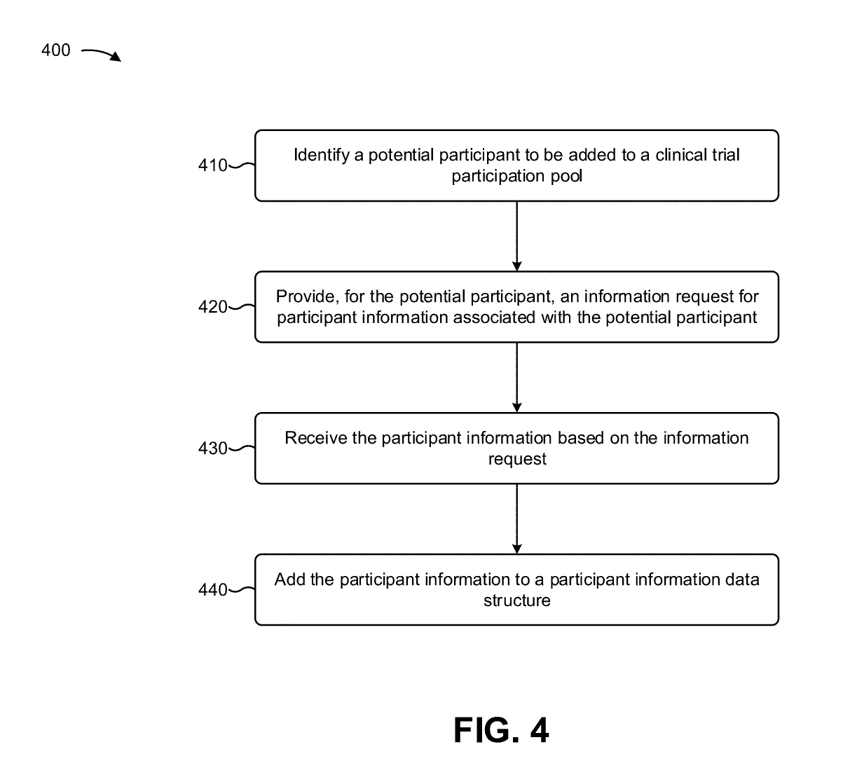

FIG. 4 is a flow chart of an example process 400 for identifying potential participants to be added to a clinical trial participation pool. In some implementations, one or more process blocks of FIG. 4 may be performed by clinical trial platform 215. In some implementations, one or more process blocks of FIG. 4 may be performed by another device or a group of devices separate from or including clinical trial platform 215, such as user device 205 and server device 210.

As shown in FIG. 4, process 400 may include identifying a potential participant to be added to a clinical trial participation pool (block 410). For example, clinical trial platform 215 may identify one or more potential participants to be considered for participation in clinical trials. In some implementations, clinical trial platform 215 may identify potential participants based on potential participants opting into consideration for participation. Additionally, or alternatively, clinical trial platform 215 may identify potential participants based on past participation in a clinical trial. In some implementations, when clinical trial platform 215 identifies potential participants, clinical trial platform 215 may add the identified potential participants to a participant information data structure, as described below.

In some implementations, a clinical trial participation pool may relate to a particular type of clinical trial. In such a case, the clinical trial participation pool may be associated with one or more particular criteria based on which to identify potential participants for the particular type of clinical trial. Types of clinical trials may be defined based on a variety of medical conditions, diseases, medications, medical devices, medical procedures or circumstances, or combinations thereof. For example, a clinical trial type may relate to a new medication, a new type of heart monitor, a specifically defined diet, a sleep study, a behavioral disorder, substance abuse, weight loss, or the like.

In some implementations, clinical trial platform 215 may identify a potential participant based on an interaction with a call to action, such as an advertisement, an email, a text message, a notification on a social network, a post on an internet forum or message board, a prompt within an app, or the like. A call to action may be provided for display via a user interface of user device 205. For example, clinical trial platform 215 may identify a plurality of potential participants based on respective interactions, by the plurality of potential participants, with calls to action that include a link based on which to provide the participant information. In some implementations, an invitation or advertisement may be provided to user device 205 associated with a potential participant, and the potential participant may interact with the user device 205 to indicate interest in selection as a potential participant. In this way, clinical trial platform 215 permits targeting of particular demographics, regions, or the like, based on the invitation or advertisement. Furthermore, by providing the call to action to user device 205 associated with potential participants, clinical trial platform 215 may increase a rate of interaction with the call to action.

In some implementations, clinical trial platform 215 may identify a potential participant based on the potential participant having participated in a clinical trial in the past. For example, when a participant has previously participated in a clinical trial, the participant information data structure may already store participant information relating to the participant. For example, the participant information data structure may store profiles corresponding to participants. In such a case, clinical trial platform 215 may access the participant information data structure to identify potential participants based on matching terms, based on a relevance search, based on location, based on profiles associated with the potential participants, or the like.

In some implementations, clinical trial platform 215 may identify a potential participant based on suitability, of the potential participant, for clinical trials. A number of factors may relate to the suitability for a clinical trial. For example, clinical trial platform 215 may identify a potential participant based on the potential participant having a medical history that matches criteria for inclusion in clinical trials. As another example, clinical trial platform 215 may identify a potential participant based on the potential participant having a medical history that does not match criteria for exclusion from clinical trials. As yet another example, clinical trial platform 215 may identify a potential participant based on the potential participant being located near a location of the clinical trial. As still another example, clinical trial platform 215 may identify a potential participant based on the potential participant expressing interest in remuneration for participation in clinical trials. As another example, clinical trial platform 215 may identify a potential participant based on physical attributes such as height, weight, or the like, satisfying a threshold. As still another example, clinical trial platform 215 may identify a potential participant based on participant demographics such as gender, age, occupation, population density, ambient information associated with a potential participant (e.g., weather, humidity, pollen count, etc.), or the like.

As further shown in FIG. 4, process 400 may include providing, for the potential participant, an information request for participant information associated with the potential participant (block 420). For example, based on identifying the potential participant, clinical trial platform 215 may provide an information request for the potential participant. In some implementations, clinical trial platform 215 may provide the information request to a user device 205 associated with the potential participant. For example, clinical trial platform 215 may determine a device identifier associated with user device 205, and may provide the information request to user device 205 based on the device identifier. In this case, clinical trial platform 215 may determine the device identifier based on an interaction with an invitation, advertisement, or the like (e.g., when identifying the potential participant). Additionally, or alternatively, clinical trial platform 215 may identify the device identifier based on the participant information data structure (e.g., when the potential participant has previously participated in one or more other clinical trials).

In some implementations, clinical trial platform 215 may provide the information request to obtain participant information associated with the potential participant. For example, the information request may include a link, an interface, or the like, via which user device 205 may receive the participant information. Participant information may include any information that is relevant or useful to administering a clinical trial. For example, participant information may include information about medical history, demographics, personal contacts, location, hobbies, diet, exercise habits, sleep habits, drug use, alcohol use, nicotine use, psychological history, employment status, occupation, work schedule, or the like.

In some implementations, the information request may include a deep link that is associated with a particular location on server device 210. The deep link may provide access to the particular location without having to access other sites or pages, open a new application, route information via clinical trial platform 215, or the like. In this case, user device 205 may provide the participant information directly to server device 210 based on the link, the network address, or the like. In this way, computational resources of clinical trial platform 215 and/or server device 210 are conserved that would otherwise be used to provide information to server device 210 via clinical trial platform 215.

As further shown in FIG. 4, process 400 may include receiving the participant information based on the information request (block 430). For example, clinical trial platform 215 may receive the participant information. In this case, the participant information may be received from participants (via user device 205) or from other sources (e.g., websites, databases, subscriber information, or medical records). In some implementations, clinical trial platform 215 may receive the participant information automatically (e.g., based on a link from user device 205, based on user device 205 automatically providing such information, or based on obtaining the information from social media or another publically available source).

In some implementations, server device 210 may receive the participant information. For example, server device 210 may receive the participant information directly from user device 205, based on a deep link, as described above. In this way, computing resources of clinical trial platform 215 are conserved. As another example, server device 210 may receive the participant information via clinical trial platform 215, which may permit clinical trial platform 215 to filter or process the participant information, thus conserving resources of server device 210.

As further shown in FIG. 4, process 400 may include adding the participant information to a participant information data structure (block 440). For example, clinical trial platform 215 may add the participant information to a participant information data structure. Additionally, or alternatively, clinical trial platform 215 may provide the participant information to another device (e.g., server device 210), which may add the participant information to the participant information data structure.

The participant information data structure may identify potential participants of the clinical trial participation pool, and may identify participant information corresponding to the potential participants. In some implementations, the participant information data structure may be a database or an appropriate component of a database that may be queried for participant information after the participant information has been added.

In some implementations, clinical trial platform 215 may determine or calculate participant information for inclusion in the participant information data structure based on information associated with the potential participant. For example, clinical trial platform 215 may determine body mass index (BMI) of the potential participant based on a height and weight of the potential participant. As another example, clinical trial platform 215 may determine a minority status based on location and demographic information associated with the potential participant. In this way, the participant information data structure allows clinical trial platform 215 to determine derivative information for use in selecting participants and/or performing clinical trials, which enables large-scale data mining that would be difficult with traditional screening methods.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

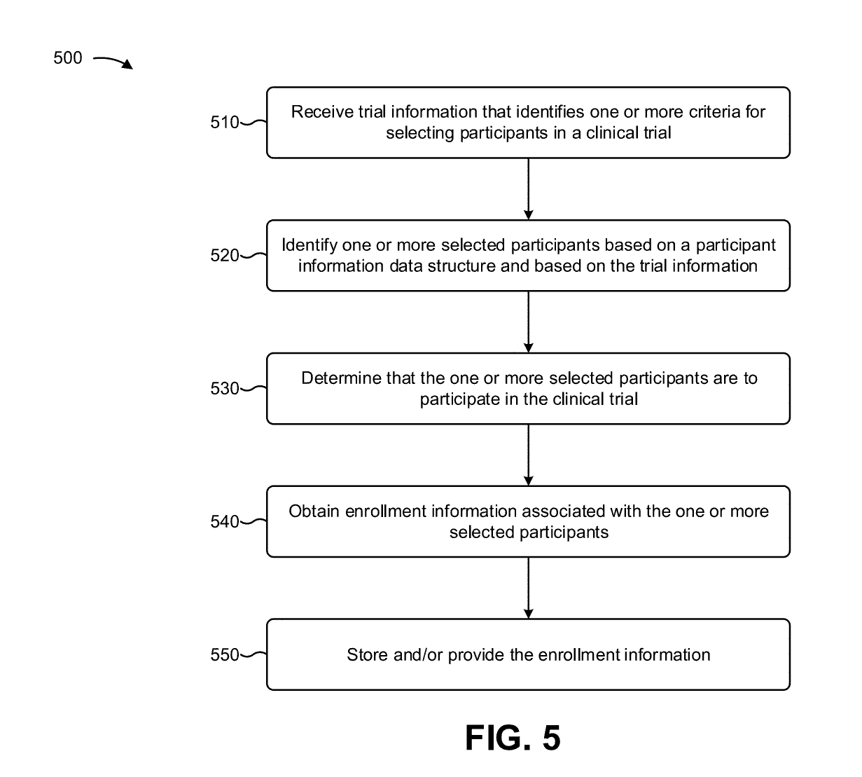

FIG. 5 is a flow chart of an example process 500 for selecting participants from a clinical trial participation pool to participate in a clinical trial. In some implementations, one or more process blocks of FIG. 5 may be performed by clinical trial platform 215. In some implementations, one or more process blocks of FIG. 5 may be performed by another device or a group of devices separate from or including clinical trial platform 215, such as user device 205 and server device 210.

As shown in FIG. 5, process 500 may include receiving trial information that identifies one or more criteria for selecting participants in a clinical trial (block 510). For example, clinical trial platform 215 may receive trial information (e.g., from user device 205 associated with an administrator of the clinical trial). In this case, the trial information may identify one or more criteria for selecting participants for participation in a clinical trial. A clinical trial may include any trial that is to be performed with regard to a group of participants. For example, a clinical trial may be performed to determine the safety and/or effectiveness of a medication, a device, a diagnostic product, or a treatment regimen. In some implementations, participants may be selected from a clinical trial participation pool based on the participant information data structure.

In some implementations, the trial information may specify rules or criteria for identifying selected participants. For example, a criterion may identify a requirement for participation, an attribute that disqualifies a potential participant from participation, or the like. In some implementations, the trial information may include a participant profile or a set of seed participants. The participant profile or set of seed participants may identify one or more participants that are associated with attributes based on which to identify selected participants. For example, the set of seed participants may identify an ideal participant profile. As another example, the set of seed participants may identify multiple participants that are associated with a set of attributes based on which to select participants. In this case, the set of seed participants may be determined based on participants in a past study. In some implementations, clinical trial platform 215 may use the participant profile or set of seed participants to select the selected participants from a pool.

As further shown in FIG. 5, process 500 may include identifying one or more selected participants based on a participant information data structure and based on the trial information (block 520). For example, clinical trial platform 215 may identify one or more selected participants for a clinical trial based on the trial information and based on a participant information data structure. A selected participant may include a person, that is identified by clinical trial platform 215 based on the participant information data structure, as appropriate to participate in a clinical trial.

In some implementations, all of the selected participants may participate in the clinical trial. Additionally, or alternatively, a subset of the selected participants may participate in the clinical trial. For example, clinical trial platform 215 may select a particular quality of selected participants (e.g., based on requirements of a clinical trial, based on an amount of resources available for the clinical trial, etc.). Additionally, or alternatively, clinical trial platform 215 may generate a ranked list of selected participants (e.g., based on suitability of the selected participants for the clinical trial).

In some implementations, clinical trial platform 215 may select the selected participants based on comparing attributes of the selected participants to the trial information. For example, the trial information may identify attributes of one or more particular participants (e.g., a participant profile, a seed participant, etc.), and clinical trial platform 215 may identify the one or more selected participants based on comparing the attributes of the one or more particular participants to the attributes of the one or more selected participants. Additionally, or alternatively, the trial information may identify one or more rules for selecting participants, and clinical trial platform 215 may identify (e.g., automatically) selected participants that match the one or more rules. In this way, clinical trial platform 215 conserves processor resources that would otherwise be used to manually select participants, or would otherwise be used to select participants based on a more complicated system, such as a holistic model.

As an example, a clinical trial may test a blood pressure medication. The trial may require participants to visit a clinical trial location once to receive the medication and a monitoring device. Trial information for the clinical trial may specify rules that participants must be male, between 45 and 65, with blood pressure that falls within a designated range, who live within 25 miles of the testing facility. Further to the example, clinical trial platform 215 may compare attributes of potential participants to the specified rules to identify selected participants. For example, a 47 year old male whose address is 17 miles from the testing facility, and whose medical history indicates a blood pressure that falls within the specified range, may be selected as a selected participant. In this way, selection of participants may be improved by expanding a range of potential participants beyond a local area, therefore potentially allowing for a larger sample of participants, a more effective sample due to a potentially more specific selection of participants, and/or a more demographically diverse range of participants.

In some implementations, clinical trial platform 215 may identify selected participants based on a model. For example, the model may receive trial information and participant information (e.g., information identifying a set of potential participants), and may output information identifying one or more selected participants of the set of potential participants. In some implementations, the model may output a score for a participant based on how closely a participant matches one or more rules. In this case, the model may identify selected participants based on the score. For example, the model may select all participants whose score satisfies a threshold. As another example, the model may rank participants based on score, and may select a top ranking subset of the participants, such as a particular number, or a particular percentage, of the participants.

In some implementations, clinical trial platform 215 may train the model based on the trial information. For example, clinical trial platform 215 may use a set of seed participants, and may use scores associated with the set of seed participants, as a training set for the model. In this way, clinical trial platform 215 improves accuracy of the model. In such a case, clinical trial platform 215 may update the model. For example, clinical trial platform 215 may update the model based on information identifying selected participants that are actually used for the clinical trial. As another example, clinical trial platform 215 may update the model based on user-inputted information indicating whether the scores associated with the selected participants are accurate. In this way, clinical trial platform 215 improves accuracy of the model and conserves processor and worker resources that would otherwise be used to specify manual rules.

As further shown in FIG. 5, process 500 may include determining that the one or more selected participants are to participate in the clinical trial (block 530). For example, clinical trial platform 215 may determine that the one or more selected participants are to participate in the trial. In some implementations, clinical trial platform 215 may determine that every selected participant is to participate in the clinical trial (e.g., automatically), which conserves computing resources that would otherwise be used to identify a subset of selected participants that are to participate in the trial.

In some implementations, clinical trial platform 215 may identify a subset of the selected participants to participate. For example, clinical trial platform 215 may select top-ranked selected participants (e.g., based on scores or ranks associated with the selected participants), participants that are closest to a particular location, geographically diverse participants, or the like. In this way, clinical trial platform 215 conserves computing resources that would otherwise be used to process a larger number of participants. Additionally, or alternatively, clinical trial platform 215 may identify participants to participate in a trial based on user input. For example, clinical trial platform 215 may provide a list of selected participants to user device 205, and user device 205 may receive an interaction to select one or more of the selected participants to participate in the trial. In this way, clinical trial platform 215 permits training of the model for identifying the selected participants based on the user selections.

As further shown in FIG. 5, process 500 may include obtaining enrollment information associated with the one or more selected participants (block 540). For example, clinical trial platform 215 may obtain enrollment information associated with the one or more selected participants. Enrollment information may be any information, not identified by the participant information data structure, that is needed to administer the clinical trial. For example, enrollment information may include informed consent information, future location information (e.g., plans of a participant to move or be unavailable in the future), information from parties associated with the selected participant (e.g., a recommendation, etc.), additional medical information, updates to medical information, user account information (e.g., if the selected participant is to self-report information via a portal), payment information for the participant, or the like.

In some implementations, clinical trial platform 215 may obtain enrollment information from the one or more selected participants. For example, clinical trial platform 215 may obtain the enrollment information based on a request for such information. As another example, clinical trial platform 215 may obtain the enrollment information based on providing a website or interface via which the one or more selected participants may input the information.

In some implementations, clinical trial platform 215 may identify enrollment information to be obtained with regard to the one or more selected participants. For example, clinical trial platform 215 may determine, based on the trial information, that each selected participant is to sign a consent form. In such a case, clinical trial platform 215 may provide the consent form to user devices 205 associated with each selected participant. As another example, clinical trial platform 215 may determine that one or more required values of participant information are not included in the participant information data structure, and may obtain, from user devices 205 associated with the one or more selected participants, the one or more required values of participant information. In this way, clinical trial platform 215 automatically identifies and obtains enrollment information based on trial information, which reduces manual input required to administrate a clinical trial.

In some implementations, clinical trial platform 215 may cause another entity to obtain the enrollment information. For example, clinical trial platform 215 may automatically schedule an appointment for the participant to visit a medical practitioner or onboarding facility, and the participant may provide this information at the appointment. In this way, organizational resources and computational resources are conserved that would otherwise be used to manually identify enrollment information to be obtained, and to manually schedule appointments to obtain the identified enrollment information.

In some implementations, clinical trial platform 215 may automatically obtain the enrollment information. For example, clinical trial platform 215 may automatically obtain the enrollment information from a social media profile of a user, or from a database of user information. In this way, clinical trial platform 215 conserves computing and worker resources that would otherwise be used to manually obtain or provide the enrollment information. Furthermore, as enrollment processing is performed by clinical trial platform 215, enrollment of a participant may not require the participant to travel to a medical facility, thus improving rates of participation and reducing expense.

As further shown in FIG. 5, process 500 may include storing and/or providing the enrollment information (block 550). For example, clinical trial platform 215 may store and/or provide the enrollment information. As a particular example, clinical trial platform 215 may add the enrollment information to the participant information data structure, or may provide the enrollment information to server device 210 to be added to the participant information data structure. In this way, the enrollment information can be used to select the participant for participation in other clinical trials, or to administer the other clinical trials. Furthermore, adding the enrollment information to the participant information data structure enables analysis of the enrollment information and the participant information data structure, which may permit determination of research conclusions, identification of unexpected correlations, or the like.

As another example, clinical trial platform 215 may provide the enrollment information to a party associated with the clinical trial (e.g., a field nurse, a medical records center, a doctor's office, etc.). As yet another example, clinical trial platform 215 may store the enrollment information locally. By storing the enrollment information locally, clinical trial platform 215 improves efficiency of administering the clinical trial, when clinical trial platform 215 is to administer the clinical trial.

By selecting trial participants in the manner described above, clinical trial platform 215 may improve matching of participants with clinical trials. Furthermore, clinical trial platform 215 may reduce reliance on humans to gather information associated with clinical trials. Additionally, by providing a deep link as described above, clinical trial platform 215 conserves processor and storage resources of clinical trial platform 215 by automatically adding data to the participant information data structure (e.g., stored by server device 210). Further, by identifying participants based on a participant information data structure, clinical trial platform 215 saves organizational and computational resources that would otherwise be used to obtain, from participants, information based on which to select the participants.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

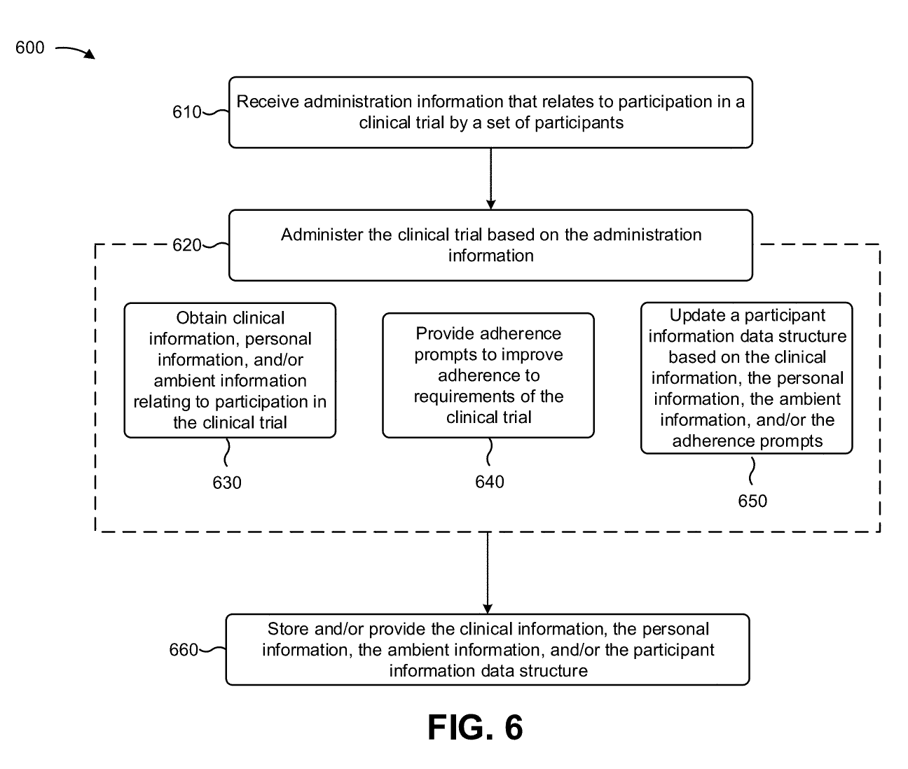

FIG. 6 is a flow chart of an example process 600 for administering a clinical trial. In some implementations, one or more process blocks of FIG. 6 may be performed by clinical trial platform 215. In some implementations, one or more process blocks of FIG. 6 may be performed by another device or a group of devices separate from or including clinical trial platform 215, such as user device 205 and server device 210.

As shown in FIG. 6, process 600 may include receiving administration information that relates to participation in a clinical trial by a set of participants (block 610). For example, clinical trial platform 215 may receive administration information. The administration information may relate to participation in a clinical trial by a set of participants, or may relate to administering the clinical trial for the set of participants. For example, the administration information may include or identify clinical, personal, and ambient information to be gathered regarding participation in the clinical trial. The clinical information may include information obtained by medically regulated devices or information obtained in a fashion that satisfies regulatory requirements. The personal information may include information gathered by a user device 205 associated with the participant, in a fashion that may or may not satisfy regulatory requirements. For example, the clinical and personal information may include information identifying medications, dosages administered, physiological measurements (body temperature, heart rate, blood pressure, etc.), chemical measurements (oxygen, glucose, insulin, carbon dioxide, etc.), observations (mental or physical responsiveness, mood, etc.), calorie intake, change in bodyweight, activity levels, sleep patterns, feedback from health care workers or from monitors or devices that measure any of the above or other attributes, or the like. Additionally, or alternatively, the administration may identify ambient information to be gathered. Ambient information may include ambient data, such as external temperature, humidity, pollen count correlated to the time and location a measurement is taken, or the like.

As another example, the administration information may identify a length of time or a number of visits associated with the clinical trial. As yet another example, the administration information may identify requirements of the clinical trial, such as things that a participant must do, eat, read, etc. for participation to be valid or rewarded, things that a participant is not allowed to do, eat, etc., places that a participant must go or must not go, activity levels a participant must exceed or not exceed, physiological or chemical measurement thresholds that a participant must exceed or not exceed, occupational tasks that a participant must be able to perform, or the like.

As further shown in FIG. 6, process 600 may include administering the clinical trial based on the administration information (block 620). For example, clinical trial platform 215 may administer the clinical trial. To administer the clinical trial, clinical trial platform 215 may obtain clinical information, personal information, and/or ambient information relating to participation in the trial, as described in more detail in connection with block 630, below. Additionally, or alternatively, clinical trial platform 215 may provide, to user devices 205 associated with participants, adherence prompts relating to requirements of the clinical trial, as described in more detail in connection with block 640, below. In some implementations, clinical trial platform 215 may administer the clinical trial automatically (e.g., without user input). In this way, clinical trial platform 215 reduces user input, thereby conserving computing and organizational resources.

As further shown in FIG. 6, process 600 may include obtaining clinical information, personal information, and/or ambient information relating to participation in the clinical trial (block 630). For example, when administering the clinical trial, clinical trial platform 215 may obtain clinical information relating to participation in the clinical trial. As explained above, clinical information includes information obtained from medically regulated devices or data otherwise collected in a fashion that satisfies regulatory requirements, personal information may include non-regulated information gathered by a user device such as a wearable device, and ambient information may include information regarding an environment associated with a participant, such as weather information, pollen count, humidity, or the like.

In some implementations, clinical trial platform 215 may obtain the clinical information, personal information, and/or ambient information from user device 205 associated with a participant. For example, clinical trial platform 215 may cause user device 205 to provide a field of a graphical user interface, in which the user can input information. In this way, clinical trial platform 215 improves the likelihood of obtaining timely and/or accurate information.

In some implementations, clinical trial platform 215 may obtain the clinical information, personal information, and/or ambient information based on providing a secure portal via which the user can provide the information. For example, clinical trial platform 215 may require a participant to provide one or more credentials to access the secure portal. As another example, clinical trial platform 215 may provide the secure portal via a secure connection (e.g., a Hypertext Transfer Protocol secure (HTTPS) connection, a Transport Layer Security (TLS) session, etc.). As yet another example, clinical trial platform 215 may require user device 205 to be located in a secure location (e.g., a medical facility, a location with a secure Internet connection, etc.) to provide the clinical information, personal information, and/or ambient information via the secure portal. In this way, clinical trial platform 215 improves security of the clinical information, personal information, and/or ambient information.

As yet another example, clinical trial platform 215 may receive or obtain the clinical information, personal information, and/or ambient information automatically, such as based on a communication with a sensor associated with user device 205 (e.g., a heart rate monitor, an onboard microphone, a Bluetooth-connected device, a location sensor, etc.). In such a case, clinical trial platform 215 may provide a message to user device 205 to cause user device 205 to obtain the clinical information, personal information, and/or ambient information. Additionally, or alternatively, clinical trial platform 215 may cause user device 205 to obtain clinical information, personal information, and/or ambient information based on a schedule (e.g., may cause user device 205 to perform a periodic measurement, may cause user device 205 to periodically prompt a participant for information, etc.). In this way, clinical trial platform 215 conserves computing resources of user device 205 that would otherwise be used to receive the clinical information, personal information, and/or ambient information based on manual input, and improves accuracy of the clinical information.

As further shown in FIG. 6, process 600 may include providing adherence prompts to improve adherence to requirements of the clinical trial (block 640). For example, clinical trial platform 215 may provide an adherence prompt to user device 205 associated with a participant. In some implementations, when administering the clinical trial, clinical trial platform 215 may determine, based on clinical information, personal information, and/or ambient information received from user device 205 associated with a particular participant, that the particular participant has violated a particular rule of the rules associated with the clinical trial. In this case, clinical trial platform 215 may provide, to user device 205, a message indicating that the particular participant has violated the particular rule. User device 205 may provide the message to the particular participant, and may thereby improve adherence of the particular participant to the particular rule and/or safety of the particular participant.

In some implementations, the adherence prompt may identify a requirement, and may indicate that the participant is to comply with the requirement. For example, if the participant leaves a particular area, the adherence prompt may prompt the participant to go back into the particular area. As another example, the adherence prompt may prompt the participant to reduce or increase a level of physical activity based on whether the participant's heart rate satisfies a threshold. As yet another example, if the participant does not move for an amount of time that satisfies a threshold, the adherence prompt may prompt the participant to move. As still another example, if the participant has not provided clinical information or personal information for a period of time that exceeds a threshold, the adherence prompt may prompt the participant to provide information and/or may provide an interface for receiving the clinical information or personal information. As another example, the adherence prompt may remind the participant to take medication. As yet another example, the adherence prompt may tell the participant to schedule a meeting.

In some implementations, the adherence prompt may relate to ambient information associated with a participant. For example, assume that a participant participates in a migraine medication trial. Assume further that an administrator of the trial knows that migraine headaches are more sever on hot, humid days. In such a case, when administering the trial, clinical trial platform 215 may obtain ambient information for participants, and may generate adherence prompts based on the ambient information. For example, when temperature and humidity values satisfy a threshold, clinical trial platform 215 may automatically provide an adherence prompt to participants indicating to stay in an air conditioned area and to stay properly hydrated. In this way, clinical trial platform 215 reduces variability of clinical trial outcomes based on ambient weather and other external factors.

In some implementations, the adherence prompt may include a message (e.g., an email message, a text message, a push notification), a phone call (e.g., an automated phone call, a phone call connected with a medical professional, etc.), an app notification (e.g., via an app installed on user device 205 and associated with clinical trial platform 215), or the like. In some implementations, clinical trial platform 215 may cause user device 205 to perform an action based on the adherence prompt. For example, when clinical trial platform 215 determines that a participant has failed to take a medication on schedule, clinical trial platform 215 may cause user device 205 to generate a set of scheduled reminders to cause the participant to take the medication on schedule.

By providing adherence prompts as described, clinical trial platform 215 improves adherence to a trial protocol, thus improving the sufficiency, quality, and/or relevancy of the data, and improves safety of the clinical trial. Furthermore, clinical trial platform 215 reduces a need for a medical professional to administer such information.

As further shown in FIG. 6, process 600 may include updating a participant information data structure based on the clinical information, the personal information, the ambient information, and/or the adherence prompts (block 650). For example, clinical trial platform 215 may update the participant information data structure based on the clinical information, the personal information, the ambient information, and/or the adherence prompts. In some implementations, clinical trial platform 215 may provide the clinical information, the personal information, the ambient information, and/or information relating to the adherence prompts to a device that stores the participant information data structure, such as server device 210, for addition to the participant information data structure. In this way, clinical trial platform 215 saves storage resources of clinical trial platform 215. Additionally, or alternatively, clinical trial platform 215 may store the clinical information, the personal information, the ambient information, and/or the adherence prompts locally. In this way, clinical trial platform 215 improves efficiency of analyzing data associated with the participant information data structure, of querying data from the participant information data structure, and of identifying participants for later clinical trials.

In some implementations, clinical trial platform 215 may identify times and subject matter associated with the adherence prompts. For example, when clinical trial platform 215 determines that a participant is not adherent to a rule, clinical trial platform 215 may provide an adherence prompt, and may add, to the participant information data structure, information that identifies the adherence prompt (e.g., a time associated with the adherence prompt, a subject matter of the rule, a remedial action associated with the adherence prompt, etc.). In this way, clinical trial platform 215 may audit adherence of a participant to a program and determine whether the adherence prompts are useful. Additionally, or alternatively, clinical trial platform 215 may facilitate analysis of the adherence prompts to determine clinical conclusions regarding treatment, adherence, or the like.

In some implementations, clinical trial platform 215 may selectively update the participant information data structure based on content of information. For example, clinical trial platform 215 may not add clinical information that is irrelevant to a clinical trial, may not add information that is not useful to selecting participants, or the like. In this way, clinical trial platform 215 conserves computing resources that would otherwise be used to store all participant information and/or adherence information.

As further shown in FIG. 6, process 600 may include storing and/or providing the clinical information, the personal information, the ambient information, and/or the participant information data structure (block 660). For example, clinical trial platform 215 may provide the clinical information, the personal information, and/or the ambient information to an administrator of the clinical study. In some implementations, clinical trial platform 215 may provide the participant information data structure (e.g., for storage by another device or for analysis by another device).

In some implementations, clinical trial platform 215 may analyze the participant information data structure. For example, clinical trial platform 215 may identify unexpected correlations in patient information based on a clinical trial (e.g., based on the clinical information, the personal information and/or the ambient information). As another example, clinical trial platform 215 may identify effectiveness of a clinical trial. As yet another example, clinical trial platform 215 may determine modifications to adherence prompts based on whether adherence prompts motivated adherence to requirements. As still another example, clinical trial platform 215 may identify outlier participants based on results of clinical trial.

In some implementations, clinical trial platform 215 may cause a participant to be rewarded or paid. For example, clinical trial platform 215 may determine that the clinical trial is complete based on the clinical information, and may cause an entity to provide payment or another type of reward to a participant (e.g., automatically, without user interaction). In some implementations, clinical trial platform 215 may notify a participant that a clinical trial has ended. Additionally, or alternatively, clinical trial platform 215 may automatically schedule a meeting (e.g., an appointment with a medical practitioner) for one or more participants in a clinical trial.

Based on administering the clinical trial as described above, the clinical trial platform may improve adherence of participants to the requirements of clinical trials. Further, the clinical trial platform may reduce reliance on humans (e.g., local medical professionals) to gather information associated with clinical trials. Additionally, automatic gathering of clinical information and/or personal information may reduce or eliminate office visits, thus conserving resources, enabling access to a larger range of participants, and improving accuracy of information. Furthermore, enrichment of a participant information data structure based on clinical information, personal information, ambient information, and adherence prompts enables analysis of patient information to identify trends and correlations, and enables reuse of the participant information data structure to select participants for future clinical trials.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Implementations described herein provide a clinical trial platform for clinical trials. The clinical trial platform may receive participant information for people who are interested in participating in clinical trials, and may add those people to a pool of available participants. The clinical trial platform may select participants for clinical trials from the pool based on attributes of the available participants. The clinical trial platform may automatically obtain additional information from the selected participants, such as signatures, consent, or the like. Based on the additional information, the clinical trial platform may create or update a data structure such as a database. In administering the clinical trial, the clinical trial platform may collect clinical information and may improve adherence to rules based on providing adherence prompts to the participants. The clinical trial platform may store the newly obtained information in association with participant profiles.

In this way, the clinical trial platform may enable analysis of participant information gathered in many different clinical trials, and may reduce double-keying of information. Additionally, the clinical trial platform may improve matching of participants with clinical trials. Furthermore, the clinical trial platform may improve adherence of participants to the requirements of the clinical trials. Still further, the clinical trial platform may reduce reliance on humans, to gather information associated with clinical trials. Additionally, the clinical trial platform may improve security of the clinical trial process.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive trial information that identifies rules or requirements associated with a clinical trial;
identify a plurality of participants associated with the clinical trial;
automatically obtain, from a user device associated with a particular participant, of the plurality of participants, first information regarding the particular participant,
the first information relating to a biometric of the particular participant or an environment associated with the particular participant;
determine that the first information indicates that the particular participant does not satisfy a particular rule or requirement associated with the clinical trial;
provide, to the user device, a prompt indicating that the particular participant does not satisfy the particular rule or requirement; and
store or provide the first information for addition to a profile associated with the particular participant.

2. The device of claim 1, where the one or more processors, when identifying the plurality of participants, are further to:
select the plurality of participants from a plurality of potential participants based on the trial information and based on participant information associated with the plurality of potential participants,
the profile associated with the particular participant identifying participant information associated with the particular participant.

3. The device of claim 2, where the one or more processors are further to:
identify the plurality of potential participants based on respective interactions, by the plurality of potential participants, with a call to action,
the call to action including a link based on which to provide the participant information.

4. The device of claim 1, where the one or more processors, when obtaining the first information, are further to:
obtain the first information via a secure connection based on the user device being located at a particular location.

5. The device of claim 1, where the one or more processors, when obtaining the first information, are to:
cause a sensor associated with the user device to obtain the first information; and
obtain the first information from the user device in real time or substantially real time.

6. The device of claim 5, where the one or more processors, when causing the user device to perform the action, are to:
cause the user device to display information that identifies the particular rule,
the information that identifies the particular rule to indicate that the particular participant has violated the particular rule.

7. The device of claim 1, where the one or more processors, when determining that the particular participant does not satisfy the particular rule or requirement, are to:
determine that the particular participant has violated the particular rule based on at least one of:
a measurement obtained by the user device,
location information obtained by the user device, or
information inputted to the user device.

8. The device of claim 1, where the one or more processors, when identifying the plurality of participants, are to:
identify the plurality of participants based on a model,
the model to receive, as input, participant information corresponding to the plurality of potential participants, and the trial information; and
the model to output information that identifies the plurality of participants.

9. A method, comprising:
receiving, by a first device, trial information that identifies rules or requirements associated with a clinical trial;
identifying, by the device, a plurality of participants associated with the clinical trial;
automatically obtaining, by the first device and from a second device associated with a particular participant, of the plurality of participants, first information regarding the particular participant,
the first information relating to a biometric of the particular participant or environmental conditions associated with the particular participant;
determining, by the first device and based on the first information, that the particular participant has violated a particular rule or requirement associated with the clinical trial;
providing, by the first device and to the second device, a prompt indicating that the particular participant has violated the particular rule or requirement; and
store or provide the first information for addition to a profile associated with the particular participant.

10. The method of claim 9, where identifying the plurality of participants comprises:
selecting the plurality of participants from a plurality of potential participants based on a model,
the model to receive, as input, the trial information and participant information that identifies attributes of the plurality of potential participants; and
the model to output information that identifies the plurality of participants and information that identifies one or more scores corresponding to the plurality of participants,
the scores being generated based on the participant information and the trial information, and
the scores indicating suitability of the plurality of participants for the clinical trial.

11. The method of claim 10, further comprising:
generating an updated model based on the model and based on information indicating whether the plurality of participants are appropriate for the clinical trial; and
identifying another one or more participants for participation in the clinical trial based on the updated model.

12. The method of claim 10, where the trial information identifies attributes of one or more seed participants; and
where identifying the plurality of participants comprises:
identifying the plurality of participants based on comparing the attributes of the one or more seed participants to the attributes of the plurality of participants.

13. The method of claim 9, where administering the clinical trial comprises:
providing a request for the first information to a user device associated with a particular participant; and
receiving, from the user device and based on the request, the first information.

14. The method of claim 9, where the first information comprises one or more of:
information obtained from a medically regulated device or data collected in a fashion that satisfies regulatory requirements, or
biometric information obtained by a sensor of the second device.

15. The method of claim 9, where the particular rule or requirement relates to compliance of the particular participant with the clinical trial or safety of the particular participant.

16. A non-transitory computer-readable medium storing instructions, the instructions comprising:
one or more instructions that, when executed by one or more processors, cause the one or more processors to:
receive trial information that identifies rules or requirements associated with a clinical trial;
identify a plurality of participants associated with the clinical trial;
automatically obtain, from a user device associated with a particular participant, of the plurality of participants, first information regarding the particular participant,
the first information relating to a biometric of the particular participant or an environment associated with the particular participant, and
the first information being obtained via a secure connection;
determine that the first information indicates that the particular participant does not satisfy a particular rule or requirement associated with the clinical trial;
provide, to the user device, a prompt indicating that the particular participant does not satisfy the particular rule or requirement; and
store or provide the first information for addition to a profile associated with the particular participant.

17. The non-transitory computer-readable medium of claim 16, where the one or more instructions, when executed by the one or more processors, cause the one or more processors to:
select the plurality of participants from a plurality of potential participants,
the plurality of participants being selected based on profiles associated with the plurality of participants.

18. The non-transitory computer-readable medium of claim 17, where the profiles associated with the plurality of participants identify one or more of:
information regarding biometrics of the plurality of participants,
locations associated with the plurality of participants,
information gathered in connection with one or more other clinical trials, or
other clinical trials in which the plurality of participants have participated.

19. The non-transitory computer-readable medium of claim 17, where the one or more instructions, when executed by the one or more processors, further cause the one or more processors to:
obtain, from the plurality of participants, second information based on identifying the plurality of participants,
the second information to include at least one of:
medical information,
consent information regarding consent to participate in the clinical trial,
one or more credentials associated with the plurality of participants, or
payment information associated with the one or more selected participants.

20. The non-transitory computer-readable medium of claim 19, where the one or more instructions, that cause the one or more processors to identify the plurality of participants, further cause the one or more processors to:
identify the plurality of participants based on respective interactions, by the plurality of participants, with a call to action,
the call to action including a link based on which to provide the second information.
